(19) United States
(12) Patent Application Publication
(10) Pub. No.: US 2020/0361142 A1
(43) Pub. Date: Nov. 19, 2020

(54) ROTATING ENERGY BEAM FOR THREE-DIMENSIONAL PRINTER

(71) Applicant: NIKON CORPORATION, Tokyo (JP)

(72) Inventors: Michael Birk Binnard, Belmont, CA (US); Motofusa Ishikawa, Tokyo (JP)

(21) Appl. No.: 16/957,992

(22) PCT Filed: Dec. 22, 2018
(86) PCT No.: PCT/US18/67406

§ 371 Date: Jun. 25, 2020

Related U.S. Application Data
(60) Provisional application No. 62/611,927, filed on Dec. 29, 2017.
(60) Provisional application No. 62/611,416, filed on Dec. 28, 2017.

(51) Int. Cl. B29C 64/153; B29C 64/241; B29C 64/268; B29C 64/386; B29C 64/245

(52) U.S. Cl. CPC B29C 64/153; B29C 64/241; B33Y 30/00; B29C 64/386; B29C 64/245; B29C 64/268

(57) ABSTRACT

A processing machine (10) for building a built part (11) includes a support device (14), a drive device (16), a powder supply device (20), and an irradiation device (24). The support device (14) includes a support surface (14A). The drive device (16) moves the support surface (14A) so that a specific position on the support surface (14A) is moved in a moving direction (30). The powder supply device (20) supplies a powder (12) to the support device (14) to form a powder layer (13). The irradiation device (24) irradiates at least a portion of the powder layer (13) with an energy beam (232) to form at least a portion of the built part (11) from the powder layer (13). Additionally, the irradiation device (24) changes an irradiation position where the energy beam (232) is irradiated to the powder layer (13) along a circumferential direction about an optical axis (234) of the irradiation device (24).

### RELATED APPLICATIONS

This application claims priority on U.S. Provisional Application No. 62/611,416 filed on Dec. 28, 2017, and entitled “THREE DIMENSIONAL PRINTER WITH ROTARY POWDER BED”. This application also claims priority on U.S. Provisional Application No. 62/611,927 filed on Dec. 29, 2017, and entitled “SPINNING BEAM COLUMN FOR THREE DIMENSIONAL PRINTER”. As far as permitted, the contents of U.S. Provisional Application Nos. 62/611,416 and 62/611,927 are incorporated in their entirety herein by reference.

### BACKGROUND

Existing powder bed three-dimensional printing systems are limited in that a large deflection angle and a large target area are not achievable without deleterious variations in focus and/or aberration performance.

### SUMMARY

The present embodiment is directed toward a processing machine for building a built part. In various embodiments, the processing machine includes a support device, a drive device, a powder supply device, and an irradiation device. The support device includes a support surface. The drive device moves the support surface so that a specific position on the support surface is moved in a moving direction. The powder supply device supplies a powder to the support device to form a powder layer. The irradiation device irradiates at least a portion of the powder layer with an energy beam to form at least a portion of the built part from the powder layer. Additionally, the irradiation device changes an irradiation position where the energy beam is irradiated to the powder layer along a circumferential direction about an optical axis of the irradiation device.

In some embodiments, the irradiation device directs the energy beam in a beam direction that crosses the optical axis. Additionally, the beam direction of the energy beam from the irradiation device may be at a constant deflection angle relative to the optical axis during change of the irradiation position on the powder layer.

In certain embodiments, the irradiation device changing the irradiation position where the energy beam is irradiated to the powder layer defines at least a portion of an annular-shaped irradiation region. In such embodiments, a location within the irradiation region as defined by the change of the irradiation position on the powder layer crosses the moving direction of the support surface.

Additionally, in some embodiments, the processing machine further includes a reference mark which is provided at a position different from the support surface. The reference mark is usable for monitoring relative position between the illumination device and the support device. The reference mark may be further positioned at a location within the irradiation region as defined by the change of the irradiation position on the powder layer.

Further, in certain embodiments, the processing machine further includes a sensor which is provided at a position different from the support surface, the sensor being configured to detect the energy beam. The sensor may be further positioned at a location within the irradiation region as defined by the change of the irradiation position on the powder layer.

In some embodiments, the specific position on the support surface passes through a location within the irradiation region as defined by the change of the irradiation position on the powder layer multiple times.

Additionally, in certain embodiments, the support surface faces in a first direction, and the moving direction of the specific position on the support surface crosses the first direction.

Further, in some embodiments, the powder supply device is arranged on the first direction side of the support device, and forms the powder layer along a surface that crosses the first direction.

Still further, in certain embodiments, the irradiation device irradiates the layer with a charged particle beam.

In another application, the present embodiment is directed toward a processing machine for building a built part, the processing machine including (i) a support device including a support surface; (ii) a drive device which moves the support device so that a specific position on the support surface is moved in a moving direction; (iii) a powder supply device which supplies a powder to the support device to form a powder layer; and (iv) an irradiation device which irradiates at least a portion of the powder layer with an energy beam to form at least a portion of the built part from the powder layer, wherein the irradiation device changes an irradiation position where the energy beam is irradiated to the powder layer along a direction crosses the moving direction, and wherein the processing machine includes a reference mark provided at a position different from the support surface.

Additionally, in still another application, the present embodiment is further directed toward a processing machine for building a built part, the processing machine Including (i) a support device including a support surface; (ii) a drive device which moves the support device so that a specific position on the support surface is moved in a moving direction; (iii) a powder supply device which supplies a powder to the support device to form a powder layer; and (iv) an irradiation device which irradiates at least a portion of the powder layer with an energy beam to form at least a portion of the built part from the powder layer, wherein the irradiation device changes an irradiation position where the energy beam is irradiated to the powder layer along a direction crosses the moving direction, and wherein the processing machine includes a sensor which is provided at a position different from the support surface, the sensor being configured to detect the energy beam.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic side view illustration of an embodiment of a processing machine having features of the present embodiment;

FIG. 2 is a simplified schematic perspective view illustration of a portion of a support device and an embodiment of an irradiation device that may be included as part of the processing machine illustrated in FIG. 1;

FIG. 3 is a simplified illustration of a possible path of the support device during use of the processing machine;

FIG. 4A is a simplified schematic top view illustration of a portion of another embodiment of the processing machine;

FIG. 4B is a simplified schematic perspective view illustration of the portion of the processing machine illustrated in FIG. 4A;

FIG. 4C is an enlarged schematic perspective view illustration of a portion of the processing machine illustrated in FIG. 4A;

FIG. 5 is a simplified schematic side view illustration of still another embodiment of the processing machine;

FIG. 6 is a simplified schematic side view illustration of yet another embodiment of the processing machine; and

FIG. 7 is a simplified schematic side view illustration of still yet another embodiment of the processing machine.

### DESCRIPTION

Embodiments are described herein in the context of a processing machine, e.g., a three-dimensional printer, including a support device, e.g., a powder bed, and a rotating energy beam that is utilized to irradiate the support device. More particularly, the irradiation device irradiates a powder layer that is formed on a support surface of the support device with the energy beam, while changing an irradiation position where the energy beam is irradiated to the powder layer.

Those of ordinary skill in the art will realize that the following detailed description of the present embodiment is illustrative only and is not intended to be in any way limiting. Other embodiments will readily suggest themselves to such skilled persons having the benefit of this disclosure. Reference will now be made in detail to implementations of the present embodiment as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

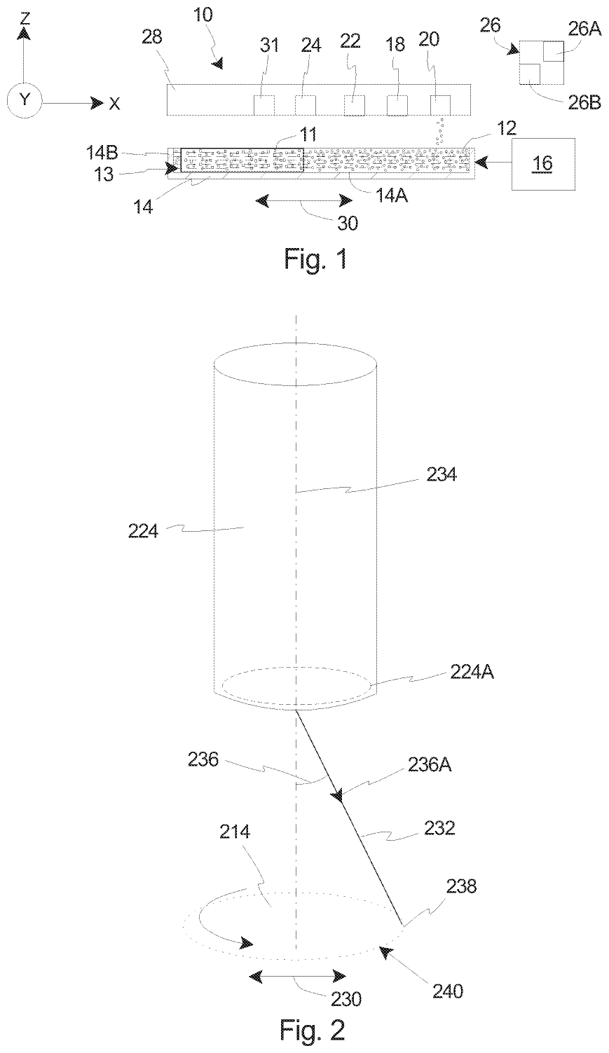

FIG. 1 is a simplified schematic side view illustration of an embodiment of a processing machine 10 having features of the present embodiment, which may be used to manufacture one or more three-dimensional objects 11 (illustrated as a box). As provided herein, the processing machine 10 may be a three-dimensional printer in which material 12 (illustrated as small circles), e.g., powder, is joined, solidified, melted, and/or fused together in a series of powder layers 13 to manufacture one or more three-dimensional object(s) 11. In FIG. 1, the object 11 includes a plurality of small squares that represent the joining of the material 12 to form the object 11.

The type of three-dimensional object(s) 11 manufactured with the processing machine 10 may be almost any shape or geometry. As a non-exclusive example, the three-dimensional object 11 may be a metal part, or another type of part, for example, a resin (plastic) part or a ceramic part etc. The three-dimensional object 11 can also be referred to as a “built part”.

Additionally, the type of material 12 joined and/or fused together may be varied to suit the desired properties of the object(s) 11. As a non-exclusive example, the three-dimensional object 11 may be a metal part, and the material 12 can include powder grains for metal three-dimensional printing. Alternatively, for example, the three-dimensional object 11 may be made of another material 12 such as a polymer, glass, ceramic precursor or resin (plastic) material.

The design of the processing machine 10, and the components utilized to form the processing machine 10, may be varied. In certain embodiments, as shown in FIG. 1, the processing machine 10 includes (i) a support device 14; (ii) a drive device 16 (illustrated as a box); (iii) a pre-heat device 18 (illustrated as a box); (iv) a powder supply device 20 (illustrated as a box); (v) a measurement device 22, or metrology system, (illustrated as a box); (vi) an irradiation device 24 (illustrated as a box); and (vii) a control system 26 that cooperate to make each three-dimensional object 11. The design of each of these components may be varied pursuant to the teachings provided herein. It should be noted that the positions of the components of the processing machine 10 may be different than that illustrated in FIG. 1. Further, it should be noted that the processing machine 10 may include more components or fewer components than illustrated in FIG. 1.

Additionally, in some embodiments, many of the components of the processing machine 10 may be retained substantially within a component housing 28. For example, in certain such embodiments, as shown in FIG. 1, the pre-heat device 18, the powder supply device 20, the measurement device 22 and the irradiation device 24 may all be retained substantially within the component housing 28. Alternatively, one or more of such components may be positioned outside of and/or remotely from the component housing 28. Still alternatively, one or more additional components of the processing machine 10 may also be retained substantially within the component housing 28. For example, in one non-exclusive alternative embodiment, the control system 26 may also be positioned substantially within the component housing 28.

As an overview, in certain embodiments, the problem of providing a large target area and deflection angle in a processing machine 10, e.g., a powder bed three-dimensional printer, which utilizes an irradiation device 24 such as a laser or an electron beam projection system, is solved by setting the energy beam from the irradiation device 24 to a fixed deflection angle and then rotating the deflection azimuth about the optical axis of the irradiation device 24.

In various embodiments, the support device 14 is a powder bed that is configured to receive a powder, i.e. the material 12, from the powder supply device 20 so that a powder layer 13 is formed on the support device 14. Stated in another manner, the support device 14 is configured to support the material 12 and the object 11 while the object 11 is being formed. In the simplified embodiment illustrated in FIG. 1, the support device 14 includes (i) a support surface 14A that faces in a first direction, i.e. generally toward the component housing 28 and/or the powder supply device 20, and is configured to receive the powder 12 from the powder supply device 20 so that the powder layers 13 are formed thereon; and (ii) one or more support walls 14B that extend upwardly from a perimeter of the support surface 14A so as to encircle the support surface 14A. In one embodiment, the support surface 14A may be substantially disk-shaped. Alternatively, the support surface 14A may be substantially rectangle-shaped, or another suitable shape. It should be noted that the support device 14 is illustrated as a cut-away in FIG. 1.

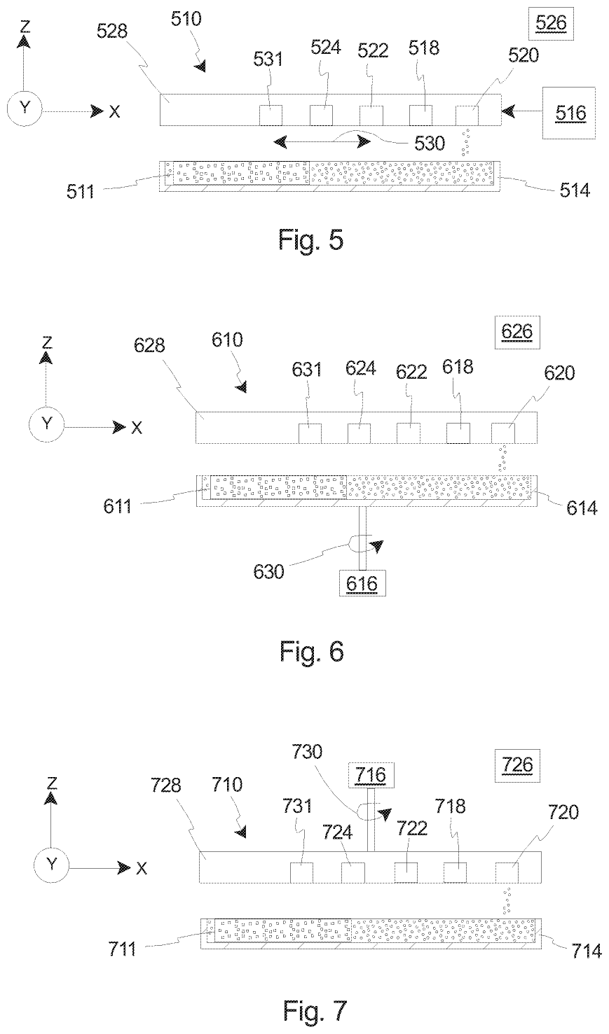

The drive device 16 (e.g., one or more actuators, and also sometimes referred to as a “device mover” or simply as a “mover”) may be utilized to provide selective relative movement between the support device 14 and the component housing 28, and thus all the components retained therein. For example, in one embodiment, as shown in FIG. 1, the drive device 16 may be utilized to move the support device 14 translationally or linearly (back and forth) in a moving direction (illustrated with an arrow 30), e.g., along a movement axis such as the X axis, relative to the component housing 28. Alternatively, in other embodiments, the drive device 16 may be utilized (i) to move the component housing 28 translationally or linearly in a moving direction, e.g., along the X axis, relative to the support device 14 (such as shown in FIG. 5); (ii) to move the support device 14 rotationally in a moving direction, e.g., about the Z axis, relative to the component housing 28 (such as shown in FIG. 6); and/or (iii) to move the component housing 28 rotationally in a moving direction, e.g., about the Z axis, relative to the support device 14 (such as shown in FIG. 7).

Additionally, or in the alternative, the drive device 16 may provide relative movement between the support device 14 and the component housing 28 up and down, e.g., along the Z axis. It is appreciated that any and all of the noted relative movements of the support device 14 and the component housing 28 may be combined in any suitable manner within any given processing machine 10. Stated in another manner, any embodiment of the processing machine 10 may include relative translational movement, e.g., back-and-forth along a movement axis (the X axis and/or the Y axis), relative vertical movement, e.g., up and down along the Z axis, and/or relative rotational movement, e.g., about the Z axis.

In some embodiments, the drive device 16 may move the support device 14 at a substantially constant velocity in the moving direction 30 relative to the component housing 28, and the various components retained therein. Alternatively, the drive device 16 may move the support device 14 at a variable velocity in the moving direction 30 relative to the component housing 28, and the various components retained herein. Further, or in the alternative, the drive device 16 may move the support device 14 in a stepped fashion relative to the component housing 28.

Additionally, in certain applications, the drive device 16 is configured to move a specific position on the support surface 14A in the moving direction 30, e.g., relative to the component housing 28. In such applications, the moving direction 30 in which the specific position of the support surface 14A is moved may be a second direction that crosses the first direction in which the support surface 14A is facing.

The pre-heat device 18 selectively preheats the material 12 that has been deposited on the support device 14, e.g., onto the support surface 14A, to a desired preheated temperature. In some embodiments, the pre-heat device 18 may pre-heat the material 12 in an area away from an irradiated area where an energy beam from the irradiation device 24 irradiates the material 12 that has been deposited on the support device 14. Additionally, in one embodiment, the pre-heat device 18 is arranged between the powder supply device 20 and the irradiation device 24 along the moving direction 30.

The design of the pre-heat device 18 and the desired preheated temperature can be varied. In one embodiment, the pre-heat device 18 may include one or more pre-heat energy source(s) that direct one or more pre-heat beam(s) at the powder 12.

If one pre-heat source is utilized, the pre-heat beam may be steered radially along a pre-heat axis to heat the powder 12. Alternatively, multiple pre-heat sources may be positioned to heat the powder 12. As alternative, non-exclusives examples, each pre-heat energy source may be an electron beam system, a mercury lamp, an infrared laser, a supply of heated air, or thermal radiation, and the desired preheated temperature may be at least 300, 500, 700, 900, or 1000 degrees Celsius.

The powder supply device 20 is arranged on the first direction side of the support device 14 and deposits the material 12 onto the support device 14, e.g., onto the support surface 14A. Additionally, with such design, the powder supply device 20 forms a powder layer 13 on the support device 14 along a surface crossing the first direction in which the support surface 14A is facing. The powder supply device 20 may have any suitable configuration for purposes of depositing the material 12 onto the support device 14 at desired locations. For example, in one embodiment, the powder supply device 20 may include one or more reservoirs (not shown) which retain the powder 12, and a powder mover (not shown) that moves the powder 12 from the reservoir(s) to above the support device 14.

Additionally, the deposition of the powder onto the support device 14 may occur at any desired speed. Further, or in the alternative, in some embodiments, metrology of deposition may be added through use of the measurement device 22, followed by a supplemental powder supply device (not shown) that could use feedback from the measurement device 22 to dynamically add or remove powder where needed.

The measurement device 22 may be used to monitor the relative position between the support device 14 and the component housing 28, and/or between the support device 14 and the measurement device 22. Additionally, the measurement device 22 may also be used to inspect and monitor the powder layer 13 and the deposition of the powder 12 onto the support device 14, e.g., onto the support surface 14A. Further, the measurement device 22 may be used to measure at least a portion of the built part 12 that is being formed on the support surface 14A. The measurement device 22 may have any suitable design for purposes of performing the various functions as noted herein. For example, in non-exclusive alternative embodiments, the measurement device 22 may include one or more of optical elements such as a uniform illumination device, fringe illumination device, camera, lens, interferometer, or photodetector, or a non-optical measurement device such as an ultrasonic, eddy current, or capacitive sensor.

The irradiation device 24 exposes the material 12, i.e. the powder, to form the powder layers 13 that becomes the object 11. More particularly, the irradiation device 24 directs an energy beam 232 (illustrated in FIG. 2), also sometimes referred to as an “illumination beam”, toward the material 12 on the support device 14 to irradiate the powder layers 13 with the energy beam 232 to form the object 11, i.e. the built part, from the powder layers 13. The irradiation device 24 may have any suitable design. For example, in one embodiment, the irradiation device 24 is a charged particle beam system, such as an electron beam system, that directs the energy beam 232, i.e. a charged particle beam such as an electron beam, toward the powder 12 on the support device 14. Alternatively, in another embodiment, the irradiation device 24 may be a laser that directs the energy beam 232, i.e. a laser beam, toward the powder 12 on the support device 14.

It is appreciated that once a powder layer 13 has been exposed, i.e. irradiated, with the irradiation device 24, and thus selected portions become melted, it is necessary to deposit another powder layer 13 on top, as evenly and uniformly as possible, until the built part 11 is completed.

The control system 26 is configured to control operations of the processing machine 10 for purposes of manufacturing the one or more three-dimensional objects 11 as desired. More particularly, the control system 26 may include one or more processors 26A and/or circuits for controlling operation of the drive device 16, the pre-heat device 18, the powder supply device 20, the measurement device 22 and the irradiation device 24. Additionally, the control system 26 may include one or more electronic storage devices 26B. In one embodiment, the control system 26 controls the components of the processing machine 10 to build the three dimensional object 11 from a computer-aided design (CAD) model by successively adding powder 12 layer by layer.

In some embodiments, the control system 26 may include, for example, a CPU (Central Processing Unit), a GPU (Graphics Processing Unit), and a memory. The control system 26 functions as a device that controls the operation of the processing machine 10 by the CPU executing the computer program. This computer program is a computer program for causing the control system 26 (for example, a CPU) to perform an operation to be described later to be performed by the control system 26 (that is, to execute it). That is, this computer program is a computer program for making the control system 26 function so that the processing machine 10 will perform the operation to be described later. A computer program executed by the CPU may be recorded in a memory (that is, a recording medium) included in the control system 26, or an arbitrary storage medium built in the control system 26 or externally attachable to the control system 26, for example, a hard disk or a semiconductor memory. Alternatively, the CPU may download a computer program to be executed from a device external to the control system 26 via the network interface. Further, the control system 26 may not be disposed inside the processing machine 10, and may be arranged as a server or the like outside the processing machine 10, for example. In this case, the control system 26 and the processing machine 10 may be connected via a communication line such as wired communications (cable communications), wireless communications, or a network. In a case of physically connecting with wired, it is possible to use serial connection or parallel connection of IEEE1394, RS-232x, RS-422, RS-423, RS-485, USB, etc. or 10BASE-T, 100BASE-TX, 1000BASE-T or the like via a network. Further, when connecting using radio, radio waves such as IEEE 802.1x, OFDM, or the like, radio waves such as Bluetooth®, infrared rays, optical communication, and the like may be used. In this case, the control system 26 and the processing machine 10 may be configured to be able to transmit and receive various types of information via a communication line or a network. Further, the control system 26 may be capable of transmitting information such as commands and control parameters to the processing machine 10 via the communication line and the network. The processing machine 10 may include a receiving device (receiver) that receives information such as commands and control parameters from the control system 26 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-Ray®, a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program may be executed in the form of software, firmware or the like. Furthermore, each processing and function included in the program may be executed by program software that may be executed by a computer, or processing of each part may be executed by hardware such as a predetermined gate array (FPGA, ASIC) or program software. Additionally, a partial hardware module that realizes a part of hardware elements may be implemented in a mixed form.

Additionally, in some embodiments, the processing machine 10 may optionally include a cooler device 31 (illustrated as a box) that cools the powder 12 on the support device 14 after fusing with the irradiation device 24. The cooler device 31 may have any suitable design. As non-exclusive examples, the cooler device 31 may utilize radiation, conduction, and/or convection to cool the newly melted metal to a desired temperature.

FIG. 2 is a simplified schematic perspective view illustration of a portion of a support device 214 and an embodiment of the irradiation device 224 that may be included as part of the processing machine 10 illustrated in FIG. 1.

As illustrated in FIG. 2, the irradiation device 224 is configured to direct an energy beam 232 generally toward the support device 214, i.e. to sequentially irradiate each of the powder layers 13 (illustrated in FIG. 1) that are formed on the support device 214 from the material 12 (illustrated in FIG. 1), e.g., powder, that has been deposited on the support device 214. Additionally, as shown, the irradiation device 224 has a device optical axis 234, and the energy beam 232 is directed toward the support device 214, and thus the powder layers 13, at a fixed deflection angle 236 relative to the device optical axis 234. Stated in another manner, the irradiation device 224 directs the energy beam 232 in a beam direction 236A that crosses the device optical axis 234. In certain non-exclusive embodiments, the deflection angle 236 of the energy beam 232 may be between approximately fifteen degrees and thirty-five degrees relative to the device optical axis 234. Alternatively, the deflection angle 236 of the energy beam 232 relative to the device optical axis 234 may be greater than thirty-five degrees or less than fifteen degrees. Stated in another fashion, in certain non-exclusive embodiments, the deflection angle 236 of the energy beam 232 may be at least 10, 15, 20, 35, 45, or 60 degrees relative to the device optical axis 234.

Further, during use of the processing machine 10, the energy beam 232 from the irradiation device 224 may be rotated about the device optical axis 234. More particularly, the irradiation device 224 may include a beam rotator 224A (illustrated with a dashed circle) that selectively rotates the energy beam 232 about the device optical axis 234. Further, with the beam rotator 224A, the deflection azimuth angle of the energy beam 232 may be easily rotated through three hundred sixty degrees (360°). Additionally, the beam direction 236A of the energy beam 232 from the irradiation device 224 is at the constant (fixed) deflection angle 236 relative to the device optical axis 234 during change of the irradiation position on the powder layers 13. Moreover, with such design, the irradiation device 224 changes the irradiation position where the energy beam 232 is irradiated to the powder layers 13 along a direction that crosses the moving direction 230 (shown again simply as translational or linear movement (back and forth) in FIG. 2) of the specific position on the support surface 14A (illustrated in FIG. 1).

The design of the irradiation device 224 may be varied. For example, as noted above, in certain non-exclusive alternative embodiments, the irradiation device 224 can be an electron beam system or a laser beam system. In particular, in one embodiment, the irradiation device 224 includes an electron beam generator that generates a focused energy beam 232 of electrons that is directed at the support device 214. In this design, the beam rotator 224A may include one or more deflection elements, and by applying sinusoidal currents or voltages to the deflection elements 224A, the deflection azimuth angle of the energy beam 232 may be easily rotated through three hundred sixty degrees (360°) at high speed. Stated in another fashion, electromagnetic fields may be adjusted to cause the azimuth angle of the energy beam 232 to be easily rotated through three hundred sixty degrees at high speed. Alternatively, for example, the irradiation device 224 may include a laser and a movable prism, mirror, or lens. With such alternative design, the prism can be rotated, i.e. with the beam rotator 224A, to cause the azimuth angle of the energy beam 232 to be easily rotated through three hundred sixty degrees at high speed. Still alternatively, the energy beam 232 from the irradiation device 224 may not be rotated. However, the energy beam 232 from the irradiation device 224 may be moved across the moving direction 30.

With such design, at a single moment in time, the energy beam 232 illuminates an irradiation area 238 that can be circular-shaped or rectangular-shaped, for example, and can be of any suitable size. For example, in certain non-exclusive embodiments, the irradiation area 238 can be circular-shaped or rectangular-shaped and have an area of between approximately 5,000 and 5,000,000 square microns on the powder layer. Stated in another fashion, in certain non-exclusive embodiments, the irradiation area 238 may have an area of at least 5,000, 50,000, 500,000, or 5,000,000 square microns on the powder layer.

It should be noted that over time, by rotating the irradiation device 224 through three hundred sixty degrees while using a fixed deflection angle 236, the irradiation device 224 may irradiate and/or expose an irradiation region 240 (shown as a dotted circle in FIG. 2) with the energy beam 232 that is in the shape of a circular annulus on the surface of the support device 214. Stated in another manner, with such design, the irradiation device 224 changes an irradiation position where the energy beam 232 is irradiated to the powder layer 13 on the support device 214 to define an annular-shaped irradiation region 240 along a circumferential direction about the device optical axis 234 of the irradiation device 224. In some non-exclusive embodiments, the irradiation region 240 may have a diameter of between approximately 10 and 500 millimeters. Stated in another fashion, in certain non-exclusive embodiments, the irradiation region 240 may have a diameter of at least 10, 50, 100, 200, or 500 millimeters.

Additionally, as the energy beam 232 rotates multiple times through the three hundred sixty degree rotation, the support surface 14A is moving in the moving direction 230. Thus, the specific position on the support surface 14A passes through a location within the irradiation region 240 multiple times. Further, a location within the irradiation region also crosses the moving direction 230 of the support surface 14A.

In most embodiments of this invention, the motion of the support surface 14A is relatively slow compared to the frequency of the three hundred sixty degree rotation of the energy beam 232. The combination of the rotational movement of the energy beam 232 and the linear or rotary motion of the support surface 14A creates a beam path on the powder surface that covers every location on the powder surface. In other words, if the target object is scanned at a slow speed relative to the rotation frequency of the energy beam 232, the full target surface on the support device 214 can be exposed. For example, in an embodiment where the irradiation area 238 has a diameter of one hundred microns and the energy beam 232 completes its three hundred sixty degree rotation at a rate of one thousand Hz, the velocity of the support surface 14A can be set to one hundred micron per millisecond, or one hundred millimeters per second.

As provided herein, with this design, because the primary focus and aberration effects of electron imaging systems depend strongly on the radial distance between the exposure point and the optical axis, the imaging performance of the irradiation device 224, e.g., the electron column, is substantially constant for every point on the irradiation region 240, i.e. the exposure circle. With the present design, because the radial distance of the energy beam 232 to the support device 214 is substantially constant, focus variations and aberration variations will be reduced. This will improve the quality of the printed part by allowing the imaging performance of the irradiation device 224 to be tuned to provide optimum imaging at the given deflection angle 236.

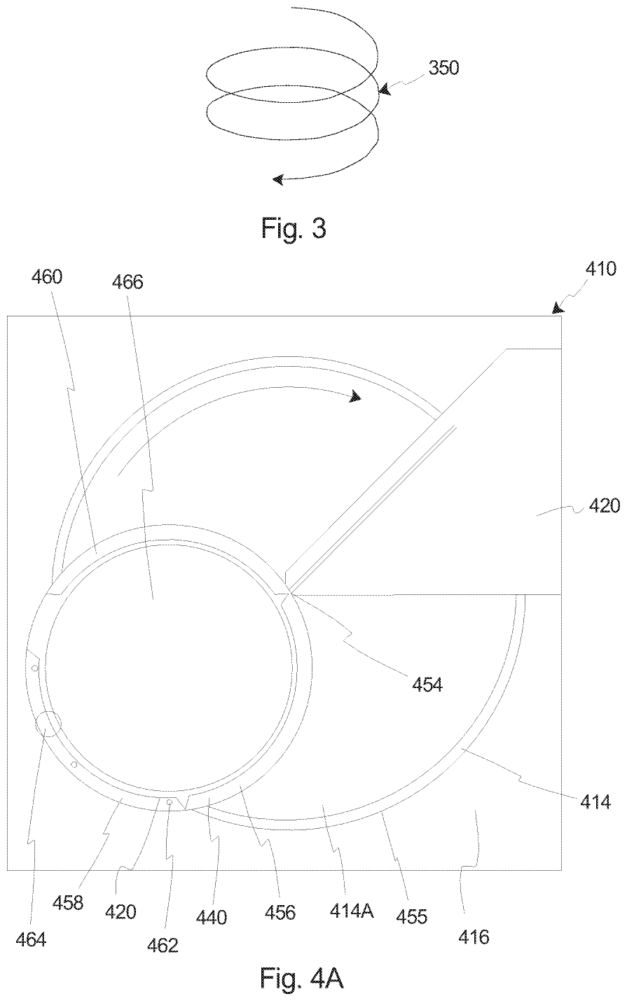

FIG. 3 is a simplified illustration of a possible path 350 of the support device within any embodiments of the processing machine illustrated herein, e.g., during three-dimensional printing. In one embodiment, the support device may be similar to the support device 614 illustrated and described herein below in relation to FIG. 6, and the support device 614 may be constantly rotated and gradually moved down during three-dimensional printing. As a result thereof, the support device 614 will follow a downward spiral path 350. In one non-exclusive embodiment, the support device 614 is moved down by approximately fifty microns during a single rotation of the support device 614. Alternatively, the support device 614 may be moved down by greater than or less than fifty microns during a single rotation of the support device 614.

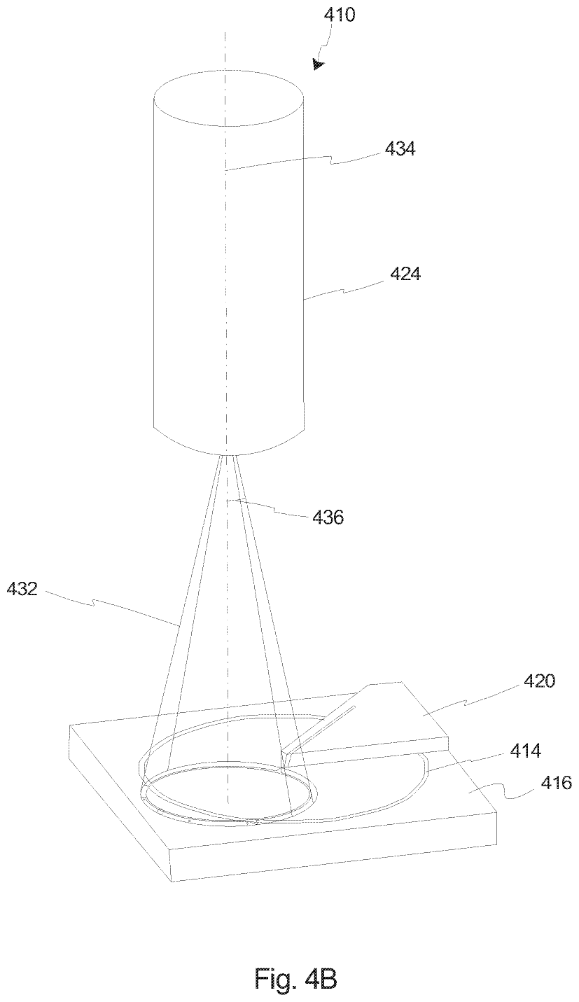

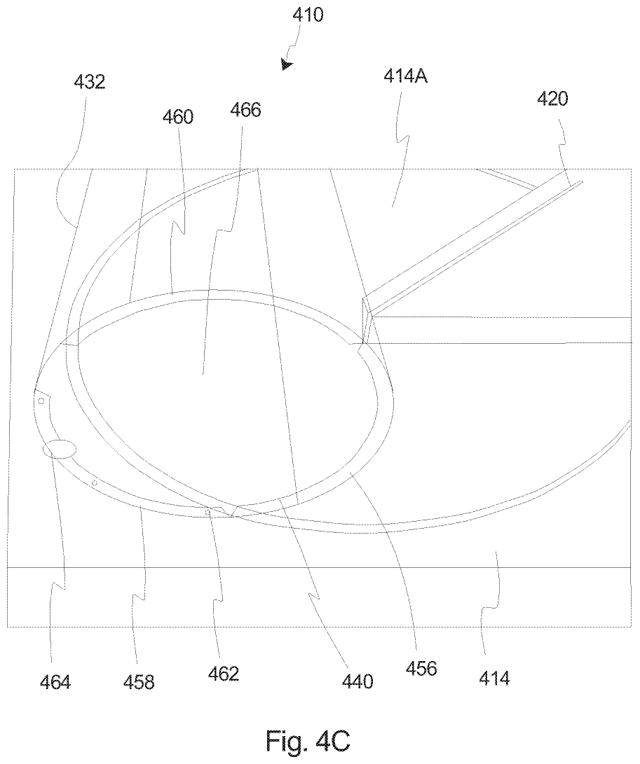

FIGS. 4A-4C are alternative views of a portion of another embodiment of the processing machine 410. More particularly, FIG. 4A is a simplified schematic top view illustration of a portion of another embodiment of the processing machine 410;

FIG. 4B is a simplified schematic perspective view illustration of the portion of the processing machine 410 illustrated in FIG. 4A; and FIG. 4C is an enlarged schematic perspective view illustration of a portion of the processing machine 410 illustrated in FIG. 4A.

Referring initially to FIG. 4A, in this embodiment, the drive device 416 may be provided in the form of a base that retains the support device 414 and, thus, the support surface 414A. During use of the processing machine 410, i.e. during three-dimensional printing, the support device 414 may be driven by the drive device 416 to constantly rotate (e.g., in a clockwise direction) the support device 414 as a turntable and to possibly move the support device 414 in a downward direction relative to the irradiation device 424 (illustrated in FIG. 4B) and the powder supply device 420. The drive device 416 may be controlled to rotate the support device 414 at any suitable speed. For example, in certain non-exclusive embodiments, the drive device 416 may be configured to rotate the support device at between approximately 2 and 60 revolutions per minute.

In some non-exclusive examples, the support device 414, i.e. the turntable, may be circular-shaped and the drive device 416 may have a rectangular-shaped outer perimeter. In one such embodiment, the support device 414 may have a radius of between approximately two hundred millimeters and four hundred fifty millimeters. Alternatively, the support device 414 and/or the drive device 416 may be other suitable shapes and sizes. For example, the support device 414 may be disk-shaped, or rectangular-shaped.

In this embodiment, the material 12 (illustrated in FIG. 1), i.e. the powder, may be continuously supplied to the support surface 414A of the support device 414 by the powder supply device 420 during rotation and general downward movement of the support device 414 relative to the irradiation device 424 and the powder supply device 420. As shown in FIG. 4A, in one embodiment, the powder supply device 420 extends to a center of rotation 454 of the support device 414. Further, the powder supply device 420 may be designed to evenly (not over or under) deposit the powder 12 on the support surface 414A over a radius of the support surface 414A. Additionally, in certain embodiments, more powder 12 is deposited on the support surface 414A as one moves away from the center of rotation 454 of the support device 414.

Referring now to FIG. 4B, as shown, the irradiation device 424 is positioned above the support device 414 (i.e. the turntable) and the drive device 416 and directs the energy beam 432 towards the support surface 414. In a similar manner to the embodiments described above, the energy beam 432 maintains a substantially constant angle 436 to the device optical axis 434 and is scanned through a three hundred sixty degree circle about the device optical axis 434 at a relatively high speed. In some non-exclusive embodiments, the irradiation device 424 may be positioned between approximately one hundred millimeters and five hundred millimeters above the support device 414. Additionally, the angle 436 between the energy beam 432 and the device optical axis 434 between approximately ten degrees and forty-five degrees. Further, as the energy beam 432 is directed through its three hundred sixty degree rotation it may illuminate a substantially annular-shaped irradiation region 440 that extends onto a portion of both the support surface 414A of the support device 414 and the drive device 416. In the non-exclusive embodiment shown in FIG. 4B, the irradiation region 440 may extend from the center of rotation 454 of the support device 414 to past a radial edge 455 (illustrated in FIG. 4A) of the support device 414 onto the drive device 416. As a non-exclusive example, the irradiation region 440 may have a diameter of between approximately fifty millimeters and two hundred fifty millimeters on the powder layer.

Referring again to FIG. 4A (and as also shown in FIG. 4C), in one, non-exclusive embodiment, an outer edge of the circular-shaped irradiation region 440, as illuminated by the energy beam 432 (illustrated in FIG. 4B) being directed toward the support device 414 (e.g., the support surface 414A) and/or the drive device 416, may include an arch-shaped (i.e. part of an annular-shaped) preheat zone 456, an arch-shaped (i.e. part of an annular-shaped) calibration zone 458, and an arch-shaped (i.e. part of an annular-shaped) build zone 460.

In the preheat zone 456, the energy beam 432 scans an arch-shaped (i.e. part of an annular-shaped) pattern over the powder 12 and delivers the necessary energy to preheat the powder 12 to a desired temperature.

In the calibration zone 458, the energy beam 432 scans an arch-shaped (i.e. part of an annular-shaped) pattern across a portion of the drive device 416. Stated in another manner, the calibration zone 458 is provided on the drive device 416, but not on the support device 414, i.e. the calibration zone 458 is in an area different from the support surface 414A.

In certain embodiments, the calibration zone 458 may be utilized in conjunction with the measurement device 22 (illustrated in FIG. 1) for purposes of monitoring relative position between the illumination device 424 and/or the powder supply device 420 and the support device 414, and the relative position and direction of the energy beam 432 and the support device 414, i.e. the turntable. More specifically, in the embodiment illustrated in FIG. 4A, the processing machine 410 may include one or more reference marks 462 (or fiducial marks) that are configured to be positioned within the calibration zone 458 of the irradiation region 440 on the drive device 416 that may be recognized by the measurement device 22 to monitor such relative position. Thus, in such embodiment, the processing machine 410 may include the reference mark(s) 462 at a position different from the support surface 414A. Additionally, in some embodiments, the reference mark(s) 462 are further positioned at a location within the irradiation region 440 as defined by the change of the irradiation position on the powder layer 13 (illustrated in FIG. 1). The position of the at least one of the reference mark(s) 462 along the Z axis may be the same as the position along the Z axis of the uppermost surface of the powder layer. The position of the at least one of the reference mark(s) 462 along the Z axis may be the same as the position along the Z axis of the support surface 414A.

As the energy beam 432 illuminates the calibration zone 458 and, thus, illuminates the reference marks 462 within the calibration zone 458, the processing machine 410 may effectively determine the relative position between the illumination device 424 and/or the powder supply device 420 and the support device 414, and evaluate whether the energy beam 432 is directed toward the support device 414 and/or the drive device 416, as desired.

As shown in this embodiment, the calibration zone 458 may also be used for detecting the energy beam 432, measuring the quality (e.g., intensity) of the energy beam 432, and/or measuring the position of the energy beam 432. In particular, as illustrated, the processing machine 410 may include one or more sensors 464 (e.g., a Faraday cup) that are configured to be positioned within the calibration zone 458 of the irradiation region 440 on the drive device 416 and that may be used to detect the energy beam 432, measure the quality or strength of the energy beam 432, and/or measure the position of the energy beam 432. Stated in another manner, in such embodiment, the processing machine 410 includes a sensor 464 provided at a position different from the support surface 414A. Additionally, the sensor 464 is further positioned at a location within the irradiation region 440 as defined by the change of the irradiation position on the powder layer 13.

As the energy beam 432 illuminates the calibration zone 458 and, thus, illuminates the sensors 464 within the calibration zone 458, the processing machine 410 may effectively determine or measure the quality of the energy beam 432. With this design, the energy beam 432 may be effectively calibrated during the three-dimensional building process.

In the build zone 460, the energy beam 432 can selectively irradiate points within an arch-shaped area of the powder 12 that has been provided on the support surface 414A to form the built part 11 (illustrated in FIG. 1) from the powder layers 13. In other words, the energy beam 432 is controlled to selectively melt the portion of powder within the build zone 460 that will become part of the built part 11.

Additionally, in some embodiments, the irradiation device 424 may be further controlled so that the energy beam 432 includes a rough build zone 466 toward the middle of the illumination region 440. In the rough build zone 466, the energy beam 432 is controlled to create a wide defocused beam that heats the powder 12 and roughly forms the built part 11. An irradiation area of the wide defocused beam may be larger than an irradiation area of the energy beam 432.

It is further appreciated that in certain embodiments, the drive device 416 may also be moved relative to the irradiation device 424 and the powder supply device 420. For example, the drive device 416 may be moved linearly, i.e. back and forth, or rotated as desired.

FIG. 5 is a simplified schematic side view illustration of still another embodiment of the processing machine 510, e.g., a three-dimensional printer, that can be used to manufacture one or more three-dimensional objects 511 (illustrated as a box). As illustrated in FIG. 5, the processing machine 510 is substantially similar to the embodiments illustrated and described herein above. For example, the processing machine 510 again includes a support device 514, a drive device 516, a pre-heat device 518, a powder supply device 520, a measurement device 522, an irradiation device 524, a control system 526 and a cooler device 531 that are substantially similar in design and function to what has been illustrated and described herein above. Additionally, as above, many of the components, e.g., the pre-heat device 518, the powder supply device 520, the measurement device 522, the irradiation device 524 and the cooler device 531, may be retained substantially within a common component housing 528. Alternatively, the plurality of devices, e.g., the pre-heat device 518, the powder supply device 520, the measurement device 522, the irradiation device 524 and the cooler device 531, may be housed in separate components, respectively.

However, in this embodiment, the drive device 516 is positioned somewhat differently, and provides a different type of relative movement between the support device 514 and the component housing 528. In particular, as shown in FIG. 5, the drive device 516 is configured to move the component housing 528 translationally (back-and-forth) in a moving direction 530, e.g., along a movement axis such as the X axis, relative to the support device 514. Additionally, the drive device 516 may also provide relative movement between the support device 514 and the component housing 528 up and down, e.g., along the Z axis.

FIG. 6 is a simplified schematic side view illustration of yet another embodiment of the processing machine 610, e.g., a three-dimensional printer, that can be used to manufacture one or more three-dimensional objects 611 (illustrated as a box). As shown in FIG. 6, the processing machine 610 is substantially similar to the embodiments illustrated and described herein above. For example, the processing machine 610 again includes a support device 614, a drive device 616, a pre-heat device 618, a powder supply device 620, a measurement device 622, an irradiation device 624, a control system 626 and a cooler device 631 that are substantially similar in design and function to what has been illustrated and described herein above. Additionally, as above, many of the components, e.g., the pre-heat device 618, the powder supply device 620, the measurement device 622, the irradiation device 624 and the cooler device 631, may be retained substantially within a common component housing 628. Alternatively, the plurality of devices, e.g., the pre-heat device 618, the powder supply device 620, the measurement device 622, the irradiation device 624 and the cooler device 631, may be housed in separate components, respectively.

However, in this embodiment, the drive device 616 is positioned somewhat differently, and provides a different type of relative movement between the support device 616 and the component housing 628. In particular, as shown in FIG. 6, the drive device 616 is configured to move the support device 614 rotationally in a moving direction 630, e.g., in a rotation direction about a rotation axis parallel to the Z axis, relative to the component housing 628. Additionally, the drive device 616 may also provide relative movement between the support device 614 and the component housing 628 up and down, e.g., along the Z axis.

FIG. 7 is a simplified schematic side view illustration of still yet another embodiment of the processing machine 710, e.g., a three-dimensional printer, that can be used to manufacture one or more three-dimensional objects 711 (illustrated as a box). As illustrated in FIG. 7, the processing machine 710 is substantially similar to the embodiments illustrated and described herein above. For example, the processing machine 710 again includes a support device 714, a drive device 716, a pre-heat device 718, a powder supply device 720, a measurement device 722, an irradiation device 724, a control system 726 and a cooler device 731 that are substantially similar in design and function to what has been illustrated and described herein above. Additionally, as above, many of the components, e.g., the pre-heat device 718, the powder supply device 720, the measurement device 722, the irradiation device 724 and the cooler device 731, may be retained substantially within a common component housing 728. Alternatively, the plurality of devices, e.g., the pre-heat device 718, the powder supply device 720, the measurement device 722, the irradiation device 724 and the cooler device 731, may be housed in separate components, respectively.

However, in this embodiment, the drive device 716 is positioned somewhat differently, and provides a different type of relative movement between the support device 714 and the component housing 728. In particular, as illustrated in FIG. 7, the drive device 716 is configured to move the component housing 728 rotationally in a moving direction 730, e.g., in a rotation direction about a rotation axis parallel to the Z axis, relative to the support device 714. Additionally, the drive device 16 may provide relative movement between the support device 714 and the component housing 728 up and down, e.g., along the Z axis.

It is understood that although a number of different embodiments of the processing machine 10 have been illustrated and described herein, one or more features of any one embodiment can be combined with one or more features of one or more of the other embodiments, provided that such combination satisfies the intent of the present invention.

While a number of exemplary aspects and embodiments of the processing machine 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A processing machine for building a built part, the processing machine comprising:
a support device including a support surface;
a drive device which moves the support device so that a specific position on the support surface is moved in a moving direction;
a powder supply device which supplies a powder to the support device to form a powder layer; and
an irradiation device which irradiates at least a portion of the powder layer with an energy beam to form at least a portion of the built part from the powder layer,
wherein the irradiation device changes an irradiation position where the energy beam is irradiated to the powder layer along a circumferential direction about an optical axis of the irradiation device.

2. The processing machine of claim 1, wherein the irradiation device directs the energy beam in a beam direction that crosses the optical axis.

3. The processing machine of claim 1, wherein the beam direction of the energy beam from the irradiation device is at a constant deflection angle relative to the optical axis during change of the irradiation position on the powder layer.

4. The processing machine of claim 1, wherein the irradiation device changing the irradiation position where the energy beam is irradiated to the powder layer defines at least a portion of an annular-shaped irradiation region, and wherein a location within the irradiation region as defined by the change of the irradiation position on the powder layer crosses the moving direction of the support surface.

5. The processing machine of claim 1, further including a reference mark which is provided at a position different from the support surface.

6. The processing machine of claim 5 wherein the reference mark is usable for monitoring relative position between the illumination device and the support device.

7. The processing machine of claim 6, wherein the irradiation device changing the irradiation position where the energy beam is irradiated to the powder layer defines at least a portion of an annular-shaped irradiation region, and wherein the reference mark is further positioned at a location within the irradiation region as defined by the change of the irradiation position on the powder layer.

8. The processing machine of claim 1, further including a sensor which is provided at a position different from the support surface, the sensor being configured to detect the energy beam.

9. The processing machine of claim 8, wherein the irradiation device changing the irradiation position where the energy beam is irradiated to the powder layer defines at least a portion of an annular-shaped irradiation region, and wherein the sensor is positioned at a location within the irradiation region as defined by the change of the irradiation position on the powder layer.

10. The processing machine of claim 1, wherein the irradiation device changing the irradiation position where the energy beam is irradiated to the powder layer defines at least a portion of an annular-shaped irradiation region, and wherein the specific position on the support surface passes through a location within the irradiation region as defined by the change of the irradiation position on the powder layer multiple times.

11. The processing machine of claim 1, wherein the support surface faces in a first direction; and wherein the moving direction of the specific position on the support surface crosses the first direction.

12. The processing machine of claim 11, wherein the powder supply device is arranged on the first direction side of the support device, and forms the powder layer along a surface that crosses the first direction.

13. The processing machine of claim 1, wherein the irradiation device irradiates the layer with a charged particle beam.

14. A processing machine for building a built part, the processing machine comprising:
a support device including a support surface;
a drive device which moves the support device so that a specific position on the support surface is moved in a moving direction;
a powder supply device which supplies a powder to the support device to form a powder layer; and
an irradiation device which irradiates at least a portion of the powder layer with an energy beam to form at least a portion of the built part from the powder layer,
wherein the irradiation device changes an irradiation position where the energy beam is irradiated to the powder layer along a direction crossing the moving direction, and wherein the processing machine includes a reference mark provided at a position different from the support surface.

15. The processing machine of claim 14 wherein the reference mark is usable for monitoring relative position between the irradiation device and/or the energy beam and the support device.

16. The processing machine of claim 15, wherein the irradiation device changing the irradiation position where the energy beam is irradiated to the powder layer defines an irradiation region, and wherein the reference mark is further positioned at a location within the irradiation region as defined by the change of the irradiation position on the powder layer.

17. The processing machine of claim 14, wherein the irradiation device irradiates the layer with a charged particle beam.

18. A processing machine for building a built part, the processing machine comprising:
a support device including a support surface;
a drive device which moves the support device so that a specific position on the support surface is moved in a moving direction;
a powder supply device which supplies a powder to the support device to form a powder layer; and
an irradiation device which irradiates at least a portion of the powder layer with an energy beam to form at least a portion of the built part from the powder layer,
wherein the irradiation device changes an irradiation position where the energy beam is irradiated to the powder layer along a direction crossing the moving direction, and wherein the processing machine includes a sensor which is provided at a position different from the support surface, the sensor being configured to detect the energy beam.

19. The processing machine of claim 18, wherein the irradiation device changing the irradiation position where the energy beam is irradiated to the powder layer defines an irradiation region, and wherein the sensor is further positioned at a location within the irradiation region as defined by the change of the irradiation position on the powder layer.

20. The processing machine of claim 18, wherein the irradiation device irradiates the layer with a charged particle beam.

21. A processing machine for building a built part, the processing machine comprising:
a support device including a support surface;
a powder supply device which supplies a powder to the support device to form a powder layer; and
an irradiation device which irradiates at least a portion of the powder layer with a first energy beam to form at least a portion of the built part from the powder layer, and with a second energy beam to form at least a portion of the built part from the powder layer; wherein an irradiation area on the powder layer of the first energy beam is larger than an irradiation area on the powder layer of the second energy beam.

22. The processing machine of claim 21, wherein the irradiation device irradiates the powder layer with a charged particle beam.

23. The processing machine of claim 21, wherein the first energy beam includes a defocused beam.

24. A processing machine comprising:
a support device including a support surface;
a drive device which moves the support device so that a specific position on the support surface is moved in a moving direction;
a powder supply device which supplies a powder to the support device to form a powder layer; and
an irradiation device which irradiates at least a portion of the powder layer with an energy beam;
wherein the irradiation device changes an irradiation position where the energy beam is irradiated to the powder layer along a direction crossing the moving direction.

25. The processing machine of claim 24, further including a sensor which is provided at a position different from the support surface, the sensor being configured to detect the energy beam.
